(19) United States
(12) Patent Application Publication
(10) Pub. No.: US 2016/0050691 A1
(43) Pub. Date: Feb. 18, 2016

(54) Method to Improve Channel Access Opportunity in a Wireless Communications System

(71) Applicant: MEDIATEK INC., Hsinchu (TW)

(72) Inventors: Yuh-Ren Jauh, Taoyuan City (TW); James June-Ming Wang, San Marino, CA (US); Chao-Chun Wang, Taipei City (TW); Ching-Hwa Yu, Tainan City (TW); Jianhan Liu, San Jose, CA (US)

(21) Appl. No.: 14/824,393

(22) Filed: Aug. 12, 2015

Related U.S. Application Data
(60) Provisional application No. 62/036,162, filed on Aug. 12, 2014.

(51) Int. Cl. H04W 74/08; H04W 48/08; H04L 12/26

(52) U.S. Cl. CPC H04W 74/0808; H04L 43/16; H04W 48/08

(57) ABSTRACT

Methods and apparatus are provided for clear channel assessment in the Wifi network. In one novel aspect, different clear channel assessment (CCA) threshold value is set for intra-BSS and inter-BSS frames during the counting down process. A CCA procedure senses the radio channel and determines if the radio channel is busy or idle during the backoff period by comparing the signal level value of detected fames with the CCA threshold value. The counting down will be suspended if the radio channel determined to be busy. If the detected frame is inter-BSS frame, the CCA threshold value is raised. If the signal level of the detected frames is lower than the inter-BSS CCA threshold for inter-BSS fames, the radio channel is considered idle. The counting down process is resumed.

### CROSS REFERENCE TO RELATED APPLICATIONS

This application claims priority under 35 U.S.C. §119 from U.S. Provisional Application No. 62/036,162, entitled, “CCA IMPROVEMENT FOR SUPPORTING OPERATOR BSS” filed on Aug. 12, 2014; the subject matter of which is incorporated herein by reference.

### TECHNICAL FIELD

The disclosed embodiments relate generally to wireless communication, and, more particularly, to CCA improvement for supporting operator BSS.

### BACKGROUND

Wifi networks have seen exponential growth across organizations in many industries. High-density wireless networks are increasingly in demand. Many new technologies have been adopted, such as multiple input multiple output (MIMO) technology. In a traditional Wifi network deployment, the deployment of Access point (AP) of a basic service set (BSS) is carefully planned to minimize BSS overlapping. With the increasing deployment of Wifi network, overlapping BSS Wifi network has become unavoidable. For example, Wifi networks managed by multiple operators operate at the same location, such as an outdoor public Wifi network overlapping with each other and highly likely to overlap with some indoor privately managed Wifi networks. In such scenarios, the multiple managed Wifi networks, each run by independent operators, would likely overlapping each other in the coverage areas. The current Wifi standard uses carrier sense multiple access with collision avoidance (CSMA/CA) to allow multiple mobile stations to access the network without collision. When there are data frames to be sent, a mobile station starts the backoff procedure and performs clear channel assessment (CCA) procedure before it can access the network. If the medium is determined to be busy at any time during the backoff stage, the backoff procedure is suspended. The wireless communications device only resumes the backoff procedure when the channel is sensed to be idle for a DIFS period or EIFS. The channel is assessed to be idle if the measured received signal level for the channel is smaller than a CCA threshold. In the current Wifi standard, the same CCA threshold applies to all sensed traffic of the channel. In a high-density OBSS deployment, it would prolong the access procedure because the transmissions from different networks are all likely to contribute to the measured signal level of the radio channel.

To improve efficiency and the access procedure, improvement and enhancement are required for CCA.

### SUMMARY

Methods and apparatus are provided for clear channel assessment in a Wifi network. In one novel aspect, different clear channel assessment (CCA) threshold value is set for intra-BSS and inter-BSS frames. The wireless communications device, preparing for data transmission, starts a backoff procedure with a counting down process. A wireless communications device starts the CCA procedure sensing the radio channel and determines if the radio channel is busy or idle during the backoff period. The wireless communications device decodes the detected frames and determines whether the frame is an intra-BSS frame or an inter-BSS frame. The CCA threshold value is adjusted based on the determined frame type. In one embodiment, if the detected frame is an inter-BSS frame, the CCA threshold value is raised. The CCA procedure compares the signal level of the detected frames with the inter-BSS CCA threshold. If the signal level of the detected frames is lower than the inter-BSS CCA threshold, the radio channel is considered idle. The counting down process is resumed if the radio channel is idle for a DIFS/EIFS period. In one embodiment, the inter-BSS is determined based on the BSS color in SIG-A field. In another embodiment, the inter-BSS is determined by the MAC address.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates exemplary wireless networks using intra-BSS and inter-BSS CCA thresholds in accordance with embodiments of the current invention.

FIG. 2 illustrates an exemplary diagram of a wireless communications device setting different CCA threshold based on the type of the detected frame in accordance to embodiments of the current invention.

FIG. 3 illustrates an exemplary diagram of the access process for the wireless communications device when the detected frames are intra-BSS frames in accordance with embodiments of the current invention.

FIG. 4 illustrates an exemplary diagram of the access process for the wireless communications device when the detected frames are inter-BSS frames in accordance with embodiments of the current invention.

FIG. 5 illustrates detailed steps for the wireless communications device to determine whether detected frames are intra-BSS or inter-BSS frames in accordance with embodiments of the current invention.

FIG. 6 illustrates an exemplary flow chart for a wireless communications device to set different CCA threshold value based on the type of detected frames for the counting down procedure in accordance with embodiments of the current invention.

### DETAILED DESCRIPTION

Reference will now be made in detail to some embodiments of the invention, examples of which are illustrated in the accompanying drawings.

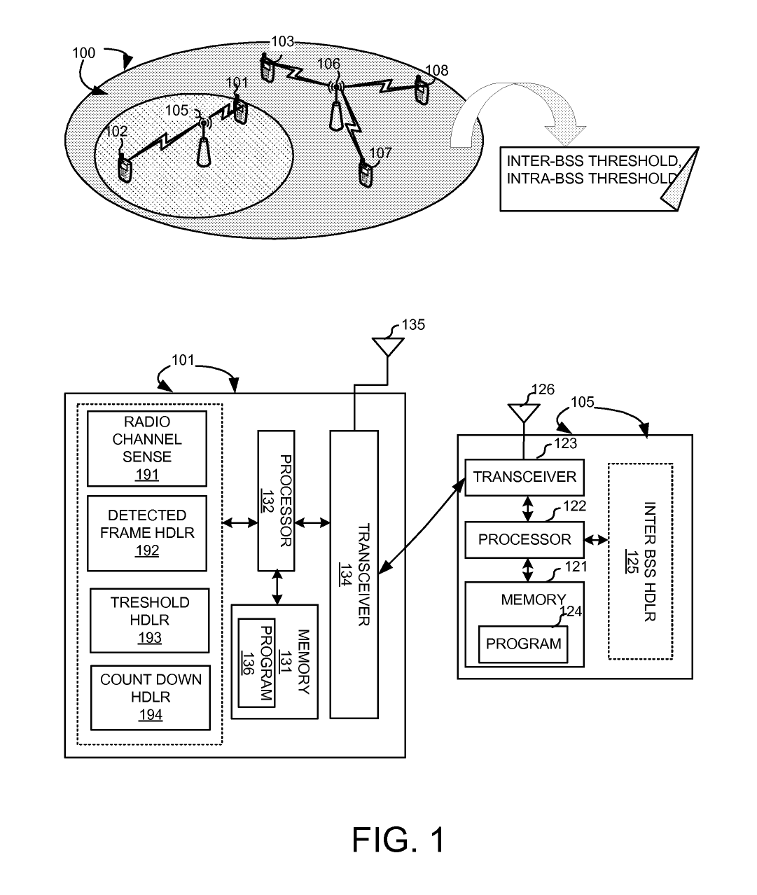

FIG. 1 illustrates an exemplary wireless network 100 using intra-BSS and inter-BSS CCA thresholds in accordance with embodiments of the current invention. Wireless communications system 100 includes one or more wireless networks, and each of the wireless communication network has fixed base infrastructure units, such as wireless communications devices 105 and 106. The base unit may also be referred to as an access point, an access terminal, a base station, or by other terminology used in the art. Each of the wireless communications stations 105 and 106 serves a geographic area. The geographic area served by wireless communications stations 105 and 106 overlaps.

Wireless communications devices 101 and 102 in the wireless network 100 are served by base station 105. Other wireless communications device, such as wireless communication device 103, 107 and 108, are served by a different base station 106.

In one novel aspect, the wireless communications device sets different CCA threshold for intra-BSS frames and inter-BSS frames. For example, wireless communications device 101 in the overlapping BSS system receives signals from both intra-BSS stations/devices, such as wireless communications device 103, and inter-BSS stations, such as wireless communications station 106. The wireless communications device first uses the initial CCA threshold to detect the traffic. Once a frame is detected and decoded frame, the wireless communications device determines whether the frame is an intra-BSS frame or an inter-BSS frame based on predefined rules. Different CCA threshold is set based on the determination of intra/inter-BSS frame. The inter-BSS CCA threshold is higher than the intra-BSS threshold.

FIG. 1 further shows simplified block diagrams of wireless stations 101 and base station 102 in accordance with the current invention.

Base station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as inter-BSS handler 125 that carry out functional tasks to configure, execute and communicate with the wireless communications device 101 inter-BSS CCA threshold related tasks.

Wireless communications device 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

Wireless communications device 101 also includes a set of control modules that carry out functional tasks. A radio-channel-sense handler 191 senses a radio channel in accordance with a first predetermined rule with a first threshold. In one embodiment, the first predetermined rule is a backoff procedure as defined in the 802.11 standard. A detected frame handler 192 decodes the detected frame and determines whether it is an intra-BSS or an inter-BSS. In one embodiment, detected frame handler 192 further determines whether the inter-BSS frame is an OBSS frame. A threshold handler 193 sets different CCA threshold based on the determined frame type. In one embodiment, threshold 194 handler sets the CCA threshold to be an intra-BSS threshold or an inter-BSS threshold based on the determined frame type. In one embodiment, threshold 193 handler further determines if the CCA threshold is the OBSS threshold or the inter-BSS threshold based on the frame type. A count down handler 194 performs the modified counting down procedure based on the CCA threshold set by threshold handler 193.

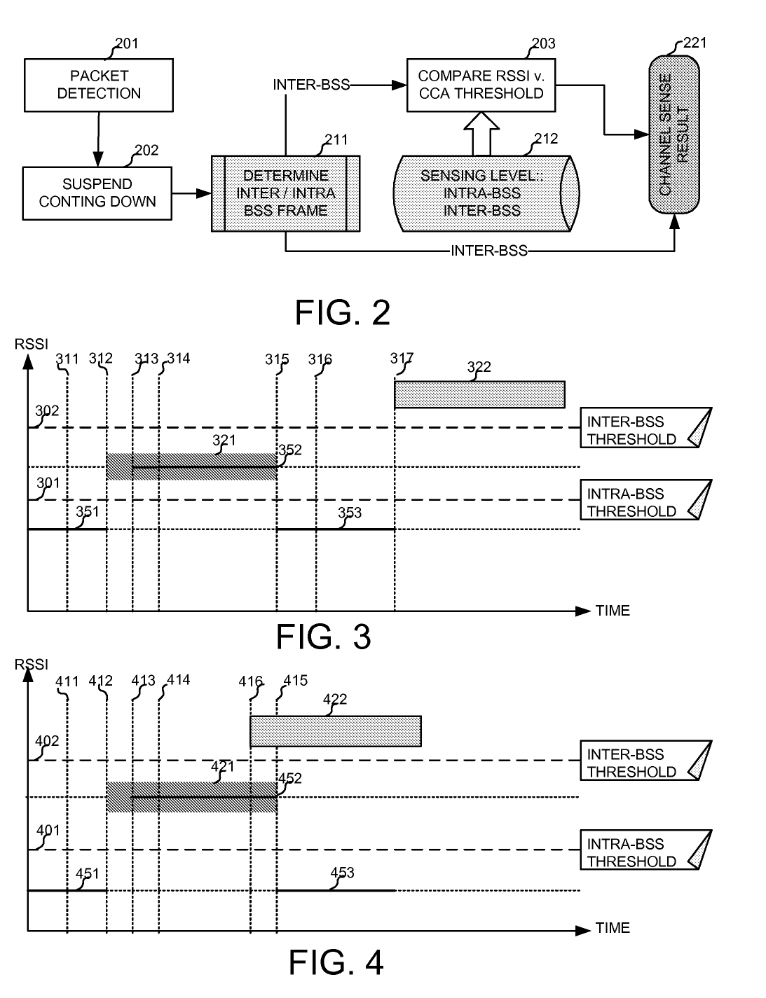

FIG. 2 illustrates an exemplary diagram of a wireless communications device setting different CCA threshold based on the type of the detected frame in accordance with embodiments of the current invention. A wireless communications device preparing to send a first frame starts the backoff procedure. At step 201, the wireless communications device detects a second frame with a signal level higher than a first CCA threshold on the radio channel during the backoff process. In one embodiment, the first CCA threshold is set to −82 dbm. At step 202, the wireless communications device suspends the counting down counter of the backoff procedure. At step 211, the wireless communications device decodes the detected second frame and determines whether it is an inter-BSS or intra-BSS frame. In one embodiment, the wireless communications device determines the inter/intra-BSS type by decoding an embedded identifier, for example a BSS color in a signal field (SIG-A) in the PHY header. The BSS color indicates whether the detected second frame is an inter-BSS or intra-BSS frame. In another embodiment, the wireless communications device decodes the MAC header of the detected second frame to get the embedded BSSID or the MAC address. The wireless communications device determines whether the detected second frame is an inter/intra-BSS frame based on the BSSID or the MAC address. If step 211, the wireless communications device determines the detected second frame is an intra-BSS frame, the wireless communications device moves to step 221 and determines the CCA results as being busy. If step 211 determines the detected second frame is an inter-BSS frame, the wireless communications device moves to step 212. At step 212, based on the determined frame type, the wireless communications device sets the second CCA threshold value to be the inter-BSS level. In one embodiment, the second CCA threshold is −62 dbm. At step 203, the wireless communications device compares the detected second frame's signal level with the second CCA threshold value set at step 212. The wireless communications device at step 221 determines the channel sense results. If the detected signal level is greater or equal to the second CCA threshold value, the radio channel is determined to be not idle. If the detected signal level is smaller than the CCA threshold value, the radio channel is determined to be idle. If the channel is determined to be idle, the communications device resume the counting down process and transmits the first frame when the counting down process ends.

FIG. 3 illustrates an exemplary diagram of the access process for the wireless communications device when the detected frames are intra-BSS frames in accordance with embodiments of the current invention. Two different CCA threshold levels are set for the wireless communications device in a BSS system. CCA threshold level 301 is an intra-BSS CCA threshold level. CCA threshold level 302 is an inter-BSS CCA threshold level. The inter-BSS CCA threshold level is higher the intra-BSS CCA threshold level. At step 311, in preparing for sending a data frame 322 on the radio channel, a wireless communications device starts the backoff procedure by starting the counting down procedure. The wireless communications device senses the radio channel during the backoff period. The signal level 351 is lower than the CCA threshold level 301. The wireless communications device continues with the counting down process. At step 312, data frame 321 was transmitted on the radio channel. At step 313, the wireless communications device gets the signal level measurement results of the detected data frame 321. The measured signal level becomes signal level 352. Signal level 352 is higher than CCA intra-BSS threshold level 301. At step 313, the wireless communications device suspends the count procedure and starts to decode the detected data frame.

In one novel aspect, the wireless communications device determines whether the detected data frame is an intra-BSs frame or inter-BSS frame. In one embodiment, the wireless communications device decodes SIG-A in the PHY header and gets an identifier of a BSS, BSS color. In another embodiment, the wireless communications device decodes the MAC header. In one example, as shown in FIG. 3, the wireless communications device determines at step 314, that the detected frame is an intra-BSS frame. The counting down procedure continues to be suspended. At step 315, the transmission of the data frame 321 ends. Subsequently, the measured signal level drops back to signal level 353, which is lower than the intra-BSS CCA level 301. The wireless communications device continues sensing the radio channel for DIFS or EIFS period. At step 316, the DIFS or EIFS period expires with the signal level lower than the CCA level 301. The wireless communications device determines that the radio channel has been idle for the DIFS/EIFS period. At step 316, the wireless communications device resumes the counting down procedure. At step 317, the counting down procedure completes while the signal level stays below CCA threshold level 301. At step 317, the wireless communications device sends its data frame 322.

FIG. 4 illustrates an exemplary diagram of the access process for the wireless communications device when the detected frames are inter-BSS frames in accordance with embodiments of the current invention. Two different CCA threshold levels are set for wireless communications device in an overlapping BSS system. CCA threshold level 401 is an intra-BSS CCA threshold level. CCA threshold level 402 is the inter-BSS CCA threshold level. At step 411, in preparing for sending a frame on the radio channel, the wireless communications device starts the backoff procedure and starts the counting down procedure. The wireless communications device senses the radio channel during the back off period. The signal level 451 is lower the CCA threshold level 401. The wireless communications device continues with the counting down. At step 412, a data frame 421 is transmitted on the radio channel. At step 413, the wireless communications device gets the signal level measurement results for the frame 421. The measured signal level becomes signal level 452. Signal level 452 is higher than CCA intra-BSS threshold level 401. At step 413, the wireless communications device suspends the count procedure and starts to decode the frame 421.

In one novel aspect, the wireless communications device determines whether the detected frame is an intra-BSS frame, or an inter-BSS frame. In one example, at step 413, the wireless communications device determines that the detected frame is an inter-BSS frame. The wireless communications device updates the CCA threshold level to inter-BSS CCA level 402. If the signal level of the frame 421 is lower than the newly updated CCA threshold level, the radio channel is determined to be idle. The wireless communications device resumes the backoff procedure in accordance with a second predefined rule. In one embodiment, the second predefined rule is to resume the counting down process if the medium is determined to be idle for DIFS/EIFS period. At step 413, the wireless communications device continues sensing the radio channel for DIFS or EIFS period. At step 414, the DIFS or EIFS period expires with the signal level lower than the CCA level 402. At step 414, the wireless communications device resumes the counting down procedure. At step 416, the counting down procedure completes. At step 416, the wireless communications device sends its data frame 422. At step 415, the transmission of inter-BSS frame 421 ends. In accordance with the embodiments of the current invention, the transmission of frame 422 overlap with inter-BSS frame 421.

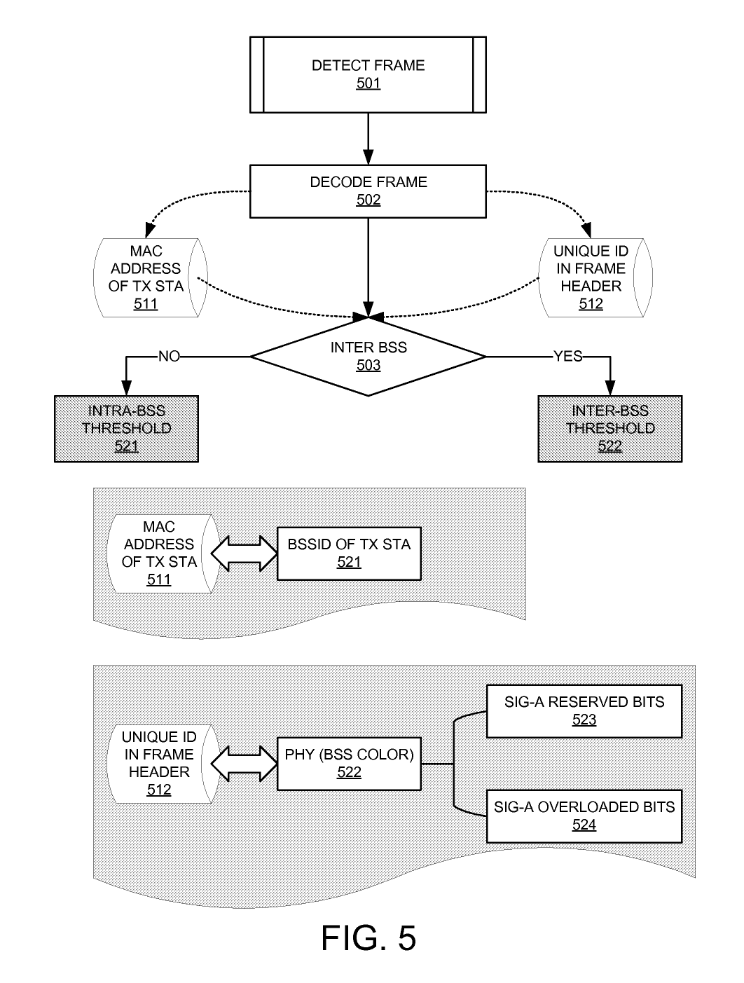

FIG. 5 illustrates detailed steps for the wireless communications device to determine whether detected frames are intra-BSS or inter-BSS frames in accordance with embodiments of the current invention. At step 501, the wireless communications device detects frames on the radio channel. At step 502, the wireless communications device decodes the detected second frames. In one embodiment, the wireless communications device decodes the MAC header to get the BSSID or the MAC address at step 511. In another embodiment, at step 512, the wireless communications device decodes a unique identifier in the frame header of the detected second frame. The BSS color indicates the received frames are from inter BSS or intra BSS. At step 503, the wireless communications device determines whether the frame is an intra-BSS or inter-BSS frame based on the result from step 511 or 512. If step 503 determines the detected frames are intra-BSS frames, the wireless communications device moves to step 521 and sets the CCA threshold value to an intra-BSS threshold. If step 503 determines the detected frames are inter-BSS frames, the wireless communications device moves to step 522 and sets the CCA threshold value to an inter-BSS threshold. The inter-BSS threshold is higher than the intra-BSS threshold.

FIG. 5 further illustrates detailed frame structures to determine whether the detected second frame is an intra-BSS frame or an inter-BSS frame. In one embodiment, by decoding the MAC address 511 of the corresponding transmitting wireless communications device, the wireless communications device may obtain the BSSID of the transmitting device, and thereby, determines whether the second frame is an intra-BSS frame or an inter-BSS frame. In another embodiment, a unique ID is decoded from the frame header. In one embodiment, the frame header is the BSS color in the SIG-A field in PHY 522. In one embodiment, globally reserved bits 523 in SIG-A field are used to indicate whether the second frame is an intra-BSS frame or an inter-BSS frame. In another embodiment, one or more bits 524 in SIG-A field are overloaded. In this embodiment, a reserved bit in the SIG-A field is used to indicate whether the one or more SIG-A bits are overloaded. If the reserved is set, the one or more bits SIG-A bits are overloaded to indicate whether the second frame is an intra-BSS frame or an inter-BSS frame.

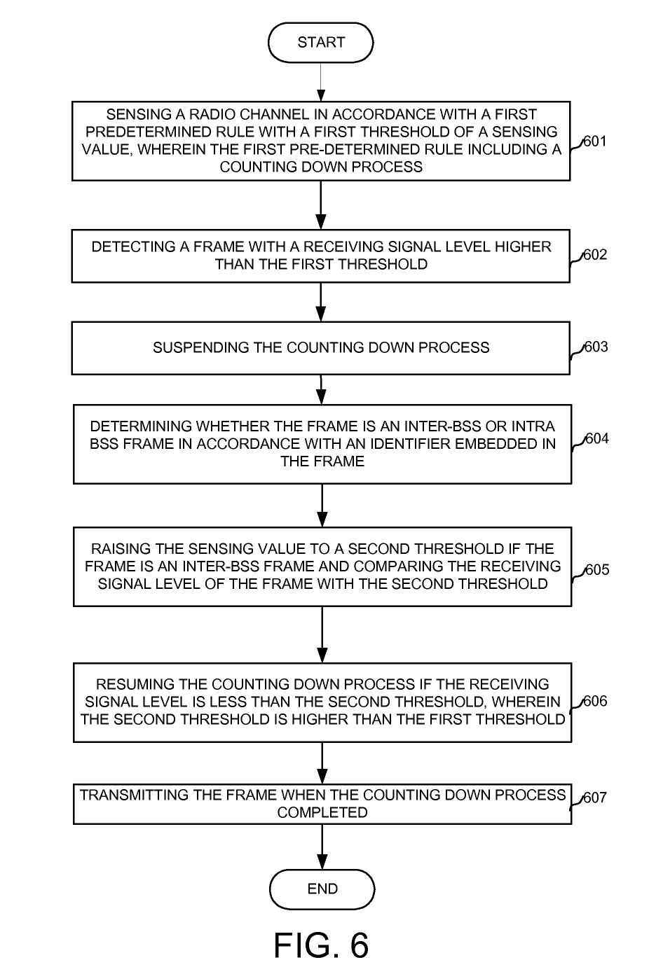

FIG. 6 illustrates an exemplary flow chart for a wireless communications device to set different CCA threshold value based on the type of detected frames for the counting down procedure in accordance with embodiments of the current invention. At step 601, the wireless communications device senses a radio channel in accordance with a first predetermined rule with a first threshold of a sensing value, wherein the first pre-determined rule including a counting down process. At step 602, the wireless communications device detects a frame with a receiving signal level higher than the first threshold. At step 603, the wireless communications device suspends the counting down process. At step 604, the wireless communications device determines whether the frame is an inter-BSS or intra BSS frame in accordance with an identifier embedded in the frames. At step 605, the wireless communications device raises the sensing value to a second threshold if the frame is an inter-BSS frame and comparing the receiving signal level of the frame with the second threshold. At step 606, the wireless communications device resumes the counting down process if the receiving signal level is less than the second threshold, wherein the second threshold is higher than the first threshold. At step 607, the wireless communications device transmits the frame when the counting down process completed.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method to increase transmission opportunities when the coverage area of one or more basic service sets (BSSs) overlapping with each other, comprising:
sensing a radio channel in accordance with a first predetermined rule with a first threshold of a sensing value before transmitting a first frame, wherein the first pre-determined rule including a counting down process;
detecting a second frame with a receiving signal level higher than the first threshold;
suspending the counting down process;
determining whether the second frame is an inter-BSS or intra BSS frame in accordance with an identifier embedded in the frame;
raising the sensing value to a second threshold if the frame is an inter-BSS frame and comparing the receiving signal level of the second frame with the second threshold;
resuming the counting down process in accordance with a second predetermined rule if the receiving signal level is less than the second threshold; and
transmitting the first frame when the counting down process completed.

2. The method of claim 1, wherein the determination of whether a second frame is an inter-BSS or intra-BSS frame is based on a unique ID carried in a frame header of the second frame.

3. The method of claim 2, the frame header is a MAC header.

4. The method of claim 2, the frame header is a PHY header.

5. The method of claim 4, wherein the identifier is set in signaling field of the second frame to indicate whether the second frame is an inter-BSS frame or an intra-BSS frame.

6. The method of claim 5, wherein one or more globally reserved BSS color bits in SIG-A field are set to indicate whether the second frame is an inter-BSS frame or an intra-BSS frame.

7. The method of claim 5, wherein a reserved bit in SIG-A field is set to indicate whether one or more bits are overloaded in the SIG-A field for inter-BSS indication, and if the reserved bit is set, one or more bits in SIG-A field are overloaded to indicate whether the second frame is an inter-BSS frame or an intra-BSS frame.

8. The method of claim 1, wherein the identifier embedded in the second frame is a MAC address of a corresponding transmitting wireless communications device of the second frame.

9. The method of claim 1 wherein the second threshold is preconfigured.

10. The method of claim 1, wherein the second threshold is adjusted dynamically based on network conditions.

11. The method of claim 10, wherein the network conditions comprising the transmitting power of a communications device, and the distance between transmitting and receiving communications device.

12. The method of claim 1, wherein the first threshold is −82 dbm, and the second threshold is −62 dbm.

13. An apparatus, comprising:
a transceiver that transmits and receives radio signals via a radio access link;
a radio channel sense module that senses a radio channel in accordance with a first predetermined rule with a first threshold of a sensing value, wherein the first pre-determined rule including a counting down process;
a detected frame handler that detects a frame with a receiving signal level higher than the first threshold and determines whether the frame is an inter basic service set (BSS) or intra BSS frame in accordance with an identifier embedded in the frame;
a threshold handler that raises the sensing value to a second threshold if the frame is an inter-BSS frame and comparing the receiving signal level of the frame with the second threshold; and
a counting down handler resuming the counting down process if the receiving signal level is less than the second threshold, wherein the second threshold is higher than the first threshold.

14. The apparatus of claim 13, wherein the determination of whether a second frame is an inter-BSS or intra-BSS frame is based on a unique ID carried in a frame header of the second frame.

15. The apparatus of claim 14, the frame header is a MAC header.

16. The apparatus of claim 14, the frame header is a PHY header.

17. The apparatus of claim 16, wherein the identifier is set in signaling field of the second frame to indicate whether the second frame is an inter-BSS frame or an intra-BSS frame.

18. The apparatus of claim 17, wherein one or more globally reserved BSS color bits in SIG-A field are set to indicate whether the second frame is an inter-BSS frame or an intra-BSS frame.

19. The apparatus of claim 17, wherein a reserved bit in SIG-A field is set to indicate whether one or more bits is overloaded in the SIG-A field for inter-BSS indication, and if the reserved bit is set, one or more bits in SIG-A field is overloaded to indicate whether the second frame is an inter-BSS frame or an intra-BSS frame.

20. The apparatus of claim 13, wherein the identifier embedded in the second frame is a MAC address of a corresponding transmitting wireless communications device of the second frame.

21. The apparatus of claim 13, wherein the second threshold is preconfigured.

22. The apparatus of claim 13, wherein the second threshold is adjusted dynamically based on network conditions.

23. The apparatus of claim 22, wherein the network conditions comprising the transmitting power of a communications device, and the distance between transmitting and receiving communications device.

24. The apparatus of claim 13, wherein the first threshold is −82 dbm, and the second threshold is −62 dbm.
